(19) United States
(12) Patent Application Publication
(10) Pub. No.: US 2026/0220738 A1
(43) Pub. Date: Jul. 30, 2026

(54) IMAGE PROCESSING APPARATUS DEVELOPING A RAW IMAGE, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Shinichi UEMURA, Kanagawa (JP)

(21) Appl. No.: 19/450,831

(22) Filed: Jan. 16, 2026

(30) Foreign Application Priority Data
Jan. 24, 2025 (JP) 2025-010641

(51) Int. Cl. G06T 3/4015; G06T 3/4007; G06T 7/11; G06T 7/194

(52) U.S. Cl. CPC G06T 3/4015; G06T 3/4007; G06T 7/11; G06T 7/194; G06T 2207/10024

(57) ABSTRACT

There is provided with an image processing apparatus. One or more processors obtain a RAW image output from a Bayer-pattern image sensor. One or more processors set a first pixel value and a second pixel value that is higher than the first pixel value. One or more processors, based on the first pixel value, the second pixel value, and a third pixel value that is a pixel value of an interpolation-target pixel in an image to be subjected to color interpolation, calculate a first weight to be used in a weighted sum. One or more processors calculate a third color interpolation coefficient by performing a weighted sum of a first color interpolation coefficient and a second color interpolation coefficient using the first weight. One or more processors develop the RAW image using the third color interpolation coefficient.

### BACKGROUND

### Field of the Technology

The present disclosure relates to an image processing apparatus, an image processing method, and a non-transitory computer-readable storage medium.

### Description of the Related Art

The technique of generating a virtual viewpoint image from a designated virtual viewpoint using a plurality of images obtained by imaging by a plurality of image capturing apparatuses is attracting attention. For example, Japanese Patent Laid-Open No. 2015-45920 discloses a method in which images of a subject are captured by installing a plurality of image capturing apparatuses at different positions, and a virtual viewpoint image is generated using the three-dimensional shape of the subject estimated from the obtained captured images.

Bayer-pattern image sensors are typically included in image capturing apparatuses, and thus RAW images are obtained from the image capturing apparatus; due to this, a virtual viewpoint image is generated after reconstructing RGB images from the obtained RAW images by means of a developing means. There are largely two types of development methods used in this developing means; one is the same-color-referencing interpolation method, in which only pixel values of the same color present in the vicinity of the interpolation-target pixel are used, and the other is the different-color-referencing interpolation method, in which reference is also made to other colors in addition to the same color. It is generally thought that image quality after development is higher with the different-color-referencing interpolation method than with the same-color-referencing interpolation method, as discussed in H. S. Malvar et al. “HIGH-QUALITY LINEAR INTERPOLATION FOR DEMOSAICING OF BAYER-PATTERNED COLOR IMAGES” [online], May 17, 2004, IEEE, IEEE Xplore, [Searched on Jan. 16, 2024]<URL: https://ieeexplore.ieee.org/document/1326587>. This is because, in natural images, there is a strong spatial correlation between the colors R, G, and B, and significant degradation occurs at edges and in high-frequency-component regions if this correlation is not taken into consideration when restoration is performed.

However, according to the different-color-referencing interpolation method, spike noise occurring in R or B would propagate to the interpolation-target G in noise-susceptible dark portions, and this noise would be prominent particularly at high ISO sensitivity. This leads to a phenomenon in which spike noise is amplified and appears as single-dot black-and-white points. Even a small single dot of noise at the time of development would lead to a degradation in texture quality because, taking the example of a camera path in which the virtual viewpoint is moved closer to the subject (subject is enlarged), the noise would be amplified due to texture having the noise superimposed thereon being enlarged. Furthermore, because the noise would also affect the separation of the subject region in the generation of a virtual viewpoint image, 3D-model shape would also be degraded.

### SUMMARY

According to one embodiment of the present disclosure, an image processing apparatus that suppresses degradation in texture and three-dimensional shape in the generation of a virtual viewpoint image is provided.

According to one embodiment of the present disclosure an image processing apparatus comprises: one or more memories storing instructions; and one or more processors executing the instructions to: obtain a RAW image output from a Bayer-pattern image sensor; set a first pixel value and a second pixel value that is higher than the first pixel value; calculate a first weight to be used in a weighted sum based on the first pixel value, the second pixel value, and a third pixel value that is a pixel value of an interpolation-target pixel in an image to be subjected to color interpolation; calculate a third color interpolation coefficient by performing a weighted sum of a first color interpolation coefficient and a second color interpolation coefficient using the first weight; and develop the RAW image using the third color interpolation coefficient.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example configuration of an image processing system according to Embodiment 1.

FIG. 2 is a block diagram illustrating an example of a hardware configuration of the image processing apparatus.

FIG. 3 includes graphs each indicating the relationship between pixel values and standard deviation values of random noise.

FIGS. 4A to 4D are diagrams for describing processing for developing an image in which a subject is imaged.

FIGS. 5A and 5B are diagrams for describing color interpolation coefficients having different characteristics.

FIG. 6 is a flowchart illustrating an example of image processing according to Embodiment 1.

FIG. 7 is a block diagram illustrating an example configuration of an image processing system according to Embodiment 2.

FIG. 8 is a flowchart illustrating an example of image processing according to Embodiment 2.

FIG. 9 is a block diagram illustrating an example configuration of an image processing system according to Embodiment 3.

FIG. 10 is a flowchart illustrating an example of image processing according to Embodiment 3.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Embodiment 1

### <Overview of Image Processing System and Virtual Viewpoint Image Generation Function>

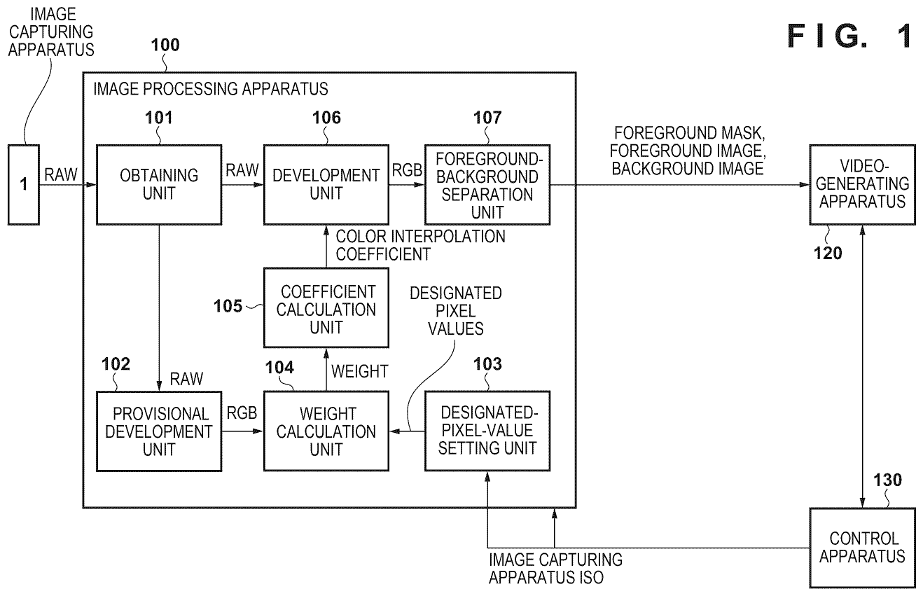

FIG. 1 is a block diagram illustrating an example of an image processing system in the present embodiment; the image processing system generates a virtual viewpoint image and includes an image processing apparatus. The image processing system illustrated in FIG. 1 includes an image capturing apparatus 1, an image processing apparatus 100, a video-generating apparatus 120, and a control apparatus 130.

A virtual viewpoint image generated by the present image processing system is also called a free-viewpoint image, and a user can freely monitor (monitor as desired) an image corresponding to a designated viewpoint. For example, an image corresponding to a viewpoint that the user has selected to monitor from among a limited number of virtual-viewpoint candidates is also a virtual viewpoint image. Note that the virtual viewpoint may be designated by user operation, or may be designated automatically based on a result of image analysis, or the like. In the following, the virtual viewpoint image may be a moving image or a still image.

For example, the virtual viewpoint image is generated according to the following method. First, a plurality of image capturing apparatuses 1 (cameras) image an imaging region including a subject from a plurality of directions. The imaging region is a three-dimensional space to be imaged, and, for example, a region having arbitrarily determined height around the pitch of a stadium may be adopted as the imaging region. Alternatively, the imaging region may be a region corresponding to a concert venue, a shooting studio, or the like. The plurality of cameras according to the present embodiment are installed at mutually different positions and directions (orientations) so as to surround the imaging region, and perform imaging in synchronization with one another.

In the present embodiment, the number of cameras included in the plurality of cameras is not limited, and, if the imaging region is a rugby stadium for example, about several tens to several hundreds of cameras may be installed around the field. Note that the plurality of cameras need not be installed over the entire perimeter of the imaging region, and may be installed in only some directions of the imaging region, depending on restrictions at the installation site, etc. Furthermore, the plurality of cameras may include cameras with different fields of view, such as a telephoto camera and a wide-angle camera. For example, by imaging a player at a high resolution using a telephoto camera, the resolution of the virtual viewpoint image to be generated can be enhanced. Furthermore, in a case in which a ball game is imaged, it can be expected that the ball would move over a wide area; thus, the number of cameras that are used can be reduced by performing imaging using a wide-angle camera. Furthermore, by performing imaging in a state in which the imaging regions of a wide-angle camera and a telephoto camera are combined, the flexibility of installation positions can be improved.

Next, the image processing apparatus 100 obtains, from each captured image, a foreground image obtained by extracting a foreground region corresponding to the subject, such as a person or a ball, and a background image obtained by extracting the background region outside the foreground region. The foreground image and the background image each include texture information (color information, etc.).

Finally, based on foreground images, the video-generating apparatus 120 generates a foreground model representing the three-dimensional shape of the subject, and texture data for coloring the foreground model. Note that a background model representing the three-dimensional shape of the background, such as a stadium, is prepared in advance. Then, the video-generating apparatus 120 generates the virtual viewpoint image by mapping the texture data to the foreground model and the background model, and performing rendering in accordance with the virtual viewpoint indicated by virtual-viewpoint information.

The control apparatus 130 is an apparatus including a display unit and an operation unit, and controls the operation of the image processing apparatus 100 or the video-generating apparatus 120. For example, the display unit is formed from a liquid-crystal display, an LED display, etc., and displays a graphical user interface (GUI) that allows the user to operate the control apparatus 130. For example, the operation unit is formed from a keyboard and a mouse, a joystick, a touch panel, etc., and receives user operations and outputs various instructions to the video-generating apparatus 120.

Here, a foreground image is an image obtained by extracting the region of the subject (foreground region) from a captured image that has been imaged and obtained by a camera. The subject extracted as the foreground region refers to a dynamic subject (moving object) that is moving (i.e., the position or shape of which may change), or the like. For example, in the case of a sport, the subject may be a person such as a player or a referee/umpire on the pitch in which the sport is being played, and, in a case in which a ball game is being imaged, the subject may be a ball or the like, as well as a person. Note that the subject is not limited to such objects, and, in a case in which a concert or a show is being imaged, a singer, a musician, a performer, a show host, etc., may be adopted as the subject constituting the foreground.

Here, a background image is an image of a region (background region) that at least differs from the subject constituting the foreground. Specifically, the background image is an image in a state in which the subject constituting the foreground has been removed from the captured image. Note that the background refers to imaged objects that remain in a stationary state or a close-to-stationary state (for a predetermined amount of time, for example) when imaged from the same direction. For example, such imaged objects include a stage of a concert or the like, a stadium in which an event such as a sport event is held, a pitch or a structure such as a goal used in a ball game, etc.

Some of the apparatuses illustrated in FIG. 1 are realized by causing a computer included in the image processing system to execute one or more computer programs stored in a memory functioning as a storage medium. However, a configuration may be adopted such that some or all of such apparatuses are realized by hardware. A dedicated circuit (ASIC), a processor (reconfigurable processor or DSP), etc., may be used as the hardware. Furthermore, not all of the image capturing apparatus 1, the image processing apparatus 100, the video-generating apparatus 120, and the control apparatus 130 included in the image processing system need to be incorporated into the same apparatus, and some or all of the apparatuses may be implemented as separate apparatuses and connected so as to be capable of communicating with one another.

### <Description of Hardware Configuration of Image Processing Apparatus 100>

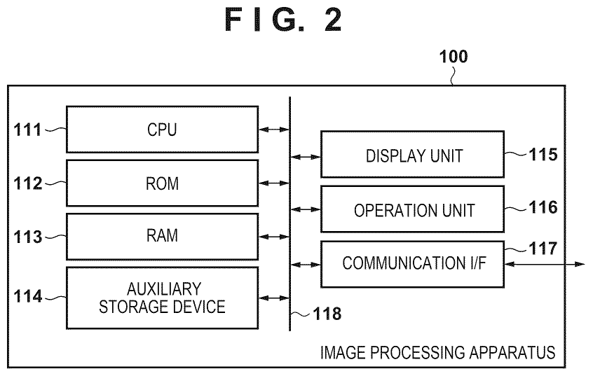

A hardware configuration of the image processing apparatus 100 will be described with reference to FIG. 2. FIG. 2 is a block diagram illustrating an example of the hardware configuration of the image processing apparatus. The image processing apparatus 100 includes a CPU 111, a ROM 112, a RAM 113, an auxiliary storage device 114, a display unit 115, an operation unit 116, a communication I/F 117, and a bus 118.

The CPU 111 realizes the functions of the image processing apparatus 100 illustrated in FIG. 1 by controlling the entire image processing apparatus 100 using one or more computer programs or data stored in the ROM 112 or the RAM 113. Note that a configuration may be adopted such that the image processing apparatus 100 includes one or more pieces of dedicated hardware different from the CPU 111, and at least part of the processing otherwise executed by the CPU 111 is executed by the dedicated hardware. Examples of such dedicated hardware include a field-programmable gate array (FPGA), a digital signal processor (DSP), etc.

The ROM 112 stores one or more programs, etc., that require no modification. The RAM 113 temporarily stores one or more programs or data supplied from the auxiliary storage device 114, data supplied from the outside via the communication I/F 117, etc.

For example, the auxiliary storage device 114 is formed from a hard disk drive or the like, and stores various types of data such as image data or audio data.

The display unit 115 is formed from a liquid-crystal display, an LED display, etc., and, for example, displays a graphical user interface (GUI) that allows the user to operate the image processing apparatus 100.

The operation unit 116 includes a keyboard, a mouse, a joystick, a touch panel, etc., and, for example, receives user operations and inputs various instructions to the CPU 111. The CPU 111 also operates as a display control unit and an operation control unit that respectively control the display unit 115 and the operation unit 116.

The communication I/F 117 is used for communication with apparatuses external to the image processing apparatus 100. For example, in a case in which a wired connection is established between the image processing apparatus 100 and an external apparatus, a communication cable is connected to the communication I/F 117. In a case in which the image processing apparatus 100 has the function of wirelessly communicating with external apparatuses, the communication I/F 117 includes an antenna. The bus 118 connects parts of the image processing apparatus 100 and transmits information.

### <Description of Configuration of Image Processing Apparatus>

A configuration of the image processing apparatus 100 according to Embodiment 1 will be described with reference to FIG. 1. The image processing apparatus 100 includes an obtaining unit 101, a provisional development unit 102, a designated-pixel-value setting unit 103, a weight calculation unit 104, a coefficient calculation unit 105, a development unit 106, and a foreground-background separation unit 107.

The obtaining unit 101 obtains an image (input image) from the image capturing apparatus 1. In the following, it is assumed that the input image obtained here is a RAW image (Bayer image).

The provisional development unit 102 generates a provisionally developed image (RGB image) by developing the RAW image using a color interpolation method that is different from that in the development by the later-described development unit 106. Here, the provisional development unit 102 can generate the provisionally developed image using nearest-neighbor interpolation as a simple color interpolation method.

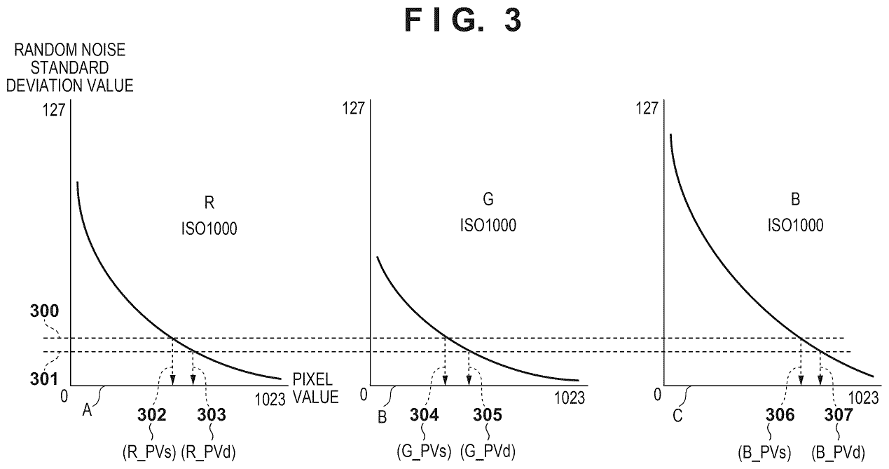

The designated-pixel-value setting unit 103 sets a plurality of pixel values to be used in the processing by the weight calculation unit 104. The pixel values set by the designated-pixel-value setting unit 103 in such a manner may be referred to as “designated pixel values”, and the processing executed by the designated-pixel-value setting unit 103 will be described in detail later with reference to FIG. 3. Note that the processing that will be described as being executed by the designated-pixel-value setting unit 103 may be executed instead by the control apparatus 130. In a case in which the designated pixel values are also changed when the ISO of the image capturing apparatus 1 is changed, the change is not executed at a short interval such as the frame period; thus, no issue of time lag arises even if the designated pixel values are set by the control apparatus 130.

Based on a pixel value in the provisionally developed image generated by the provisional development unit 102 and the designated pixel values set by the designated-pixel-value setting unit 103, the weight calculation unit 104 calculates a weight to be used in a weighted sum performed by the later-described coefficient calculation unit 105. Weights in the weighted sum according to the present embodiment are assigned to a same-color-referencing interpolation coefficient and a different-color-referencing interpolation coefficient, which will be described later, and are calculated so that the total of the weights is 1. The processing executed by the weight calculation unit 104 will be described in detail later with reference to FIG. 3.

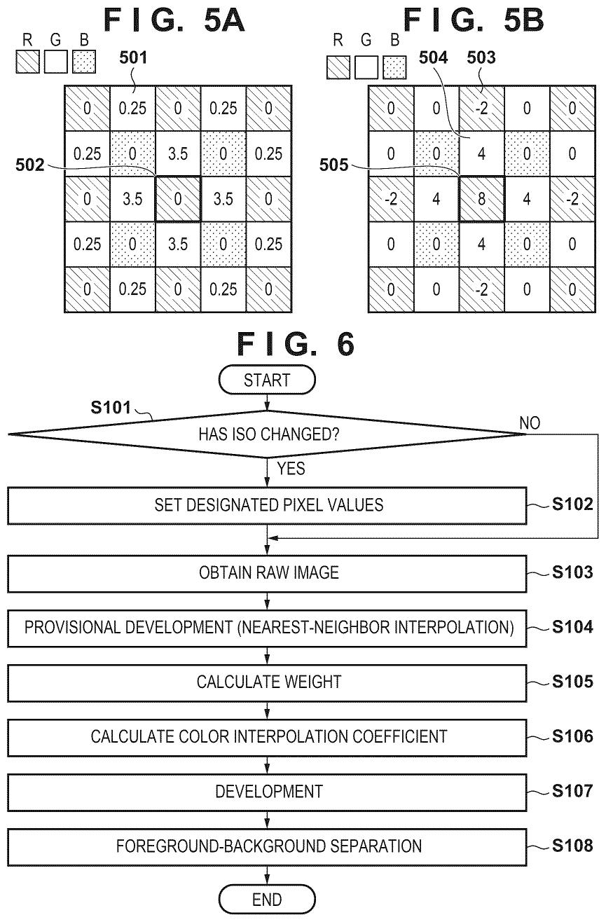

The coefficient calculation unit 105 calculates a third color interpolation coefficient by performing a weighted sum of a first color interpolation coefficient and a second color interpolation coefficient using the weight calculated by the weight calculation unit 104. The first color interpolation coefficient and the second color interpolation coefficient according to the present embodiment are color interpolation coefficients having mutually different characteristics. Herein, a coefficient used in same-color-referencing interpolation and a coefficient used in different-color-referencing interpolation are respectively used as the first color interpolation coefficient and the second color interpolation coefficient; this will be described in detail later with reference to FIGS. 5A and 5B.

The development unit 106 generates a developed image (RGB image) from the RAW image by performing development using the color interpolation coefficient calculated by the coefficient calculation unit 105.

The foreground-background separation unit 107 separates a background image and a foreground region corresponding to a predetermined subject from the developed image generated by the development unit 106. Any appropriate method conventionally used to extract the background/foreground may be used as the method for the separation of the background image and the foreground region from the image by the foreground-background separation unit 107. For example, the background image may be generated by sequential background updating. Specifically, the foreground-background separation unit 107 generates a background image obtained by extracting only the background by determining, from a plurality of input images, a region in which there is a change and a region in which there is no change over a predetermined period as the foreground and the background, respectively. Here, the foreground region is generated as a binary image (foreground mask image) by background subtraction using the input image and the generated background image. Specifically, the foreground region is generated by subjecting, to binarization using a predetermined threshold, a difference image obtained by subtracting the background image from the input image. Furthermore, for example, the foreground-background separation unit 107 may obtain an image in which the subject is not present in advance as the background image.

In the foreground mask image generated in such a manner, the foreground-background separation unit 107 can set a rectangular region circumscribing the subject as the foreground region. Furthermore, from the developed image, the image within the foreground region set in such a manner may be extracted as the foreground image. In the following, description is provided assuming that the foreground image is generated using, as the foreground region, the rectangular region set using the foreground mask image in such a manner; however, processing need not be executed in such a manner in particular if reference can be similarly made to the foreground region corresponding to the subject. For example, a configuration may be adopted such that, based on the developed image, the foreground-background separation unit 107 sets the foreground region in the developed image using a machine learning model trained so as to extract subjects from images or a technique, such as template matching, for detecting subjects from images, for example.

### <Details of Color-Interpolation-Method Determination Method>

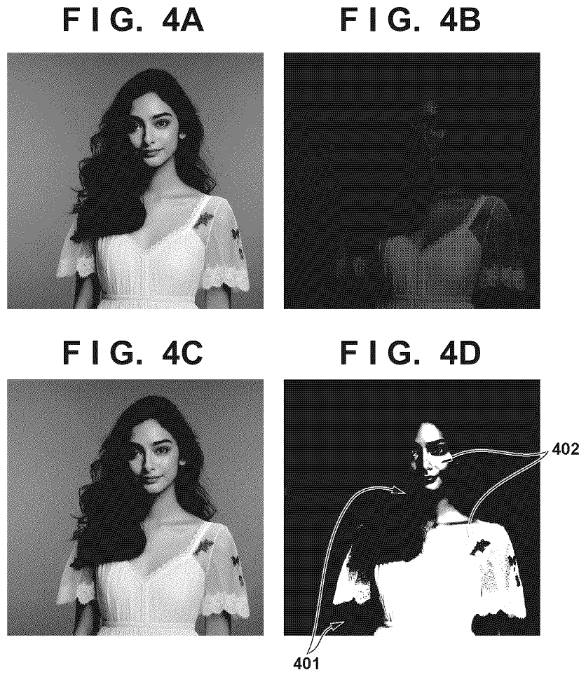

In the following, processing executed by the image processing apparatus 100 according to the present embodiment will be described with reference to the explanatory diagrams in FIG. 3, FIGS. 4A to 4D, and FIGS. 5A and 5B, and the flowchart in FIG. 6. FIG. 6 is a flowchart for describing an example of processing by the image processing apparatus 100 according to Embodiment 1. The operation in each step in the flowchart in FIG. 6 is executed by the CPU 111, which is a computer of the image processing apparatus 100, executing one or more computer programs stored in a memory such as the ROM 112 or the auxiliary storage device 114, for example. The present embodiment will be described in detail based on this flowchart. Here, the image processing apparatus 100 starts the processing illustrated in FIG. 6 as a result of an operation for starting the present image processing being received from the user by the control apparatus 130.

In step S101, the designated-pixel-value setting unit 103 obtains the ISO value of the image capturing apparatus 1 from the control apparatus 130. Processing advances to step S102 if the ISO value has been changed (or when the ISO value is initially set), and processing advances to step S103 if the ISO value has not been changed from when the ISO value was previously set.

In step S102, the designated-pixel-value setting unit 103 sets a plurality of designated pixel values (here, two types of designated pixel values) for each of the colors R, G, and B based on the ISO value obtained in step S101. Generally, the lower the pixel value is (the darker it is), the more likely noise (random noise) occurs. The designated-pixel-value setting unit 103 according to the present embodiment sets, as a first designated pixel value, a pixel value such that, when developing a RAW image by different-color-referencing interpolation, noise would be perceptually prominent from a subjective perspective if the pixel value decreases any further than this pixel value. Furthermore, the designated-pixel-value setting unit 103 according to the present embodiment sets, as a second designated pixel value, a pixel value such that, when developing a RAW image by different-color-referencing interpolation, noise would not be prominent (would be unnoticeable) from a subjective perspective if the pixel value is any higher than this pixel value. In the following, processing for setting such designated pixel values will be described with reference to FIG. 3.

In the following, it is assumed that an ISO value of 1000 has been obtained. FIG. 3 includes graphs each indicating the relationship between pixel values and the standard deviation value of ISO-induced random noise occurring at each pixel value in RAW images imaged at ISO 1000. Graph A in FIG. 3 is a graph for pixel values of the color R (red). Similarly, graph B in FIG. 3 is a graph for pixel values of the color G (green), and graph C in FIG. 3 is a graph for pixel values of the color B (blue). Here, only a case in which the ISO value is 1000 is illustrated; however, data of the graphs illustrated in FIG. 3 is present and stored in advance in the designated-pixel-value setting unit 103 for each type of ISO value that can be set in the image capturing apparatus 1, and data of graphs corresponding to the ISO value obtained in step S101 is selected therefrom. Here, pixel values are evaluated using 10 bits, i.e., using values from 0 to 1023; however, such values need not be used in particular as long as evaluation can be performed similarly.

In graph A in FIG. 3, a random noise standard deviation value such that noise would be perceptually prominent from a subjective perspective if the random noise standard deviation value increases any further than this value (hereinafter such a value is referred to as a “maximum standard deviation value”) is set as a maximum standard deviation value 300. Furthermore, in graph A in FIG. 3, a random noise standard deviation value such that noise would not be prominent (would be unnoticeable) from a subjective perspective if the random noise standard deviation value decreases any further than this value (hereinafter such a value is referred to as a “minimum standard deviation value”) is set as a minimum standard deviation value 301. The designated-pixel-value setting unit 103 according to the present embodiment sets such a maximum standard deviation value 300 and minimum standard deviation value 301. The maximum standard deviation value and minimum standard deviation value may be set by the user setting values as appropriate or may be dynamically set in accordance with pixel values in the foreground mask, etc., and can be set to desired values. An example in which the maximum standard deviation value and minimum standard deviation value are dynamically set will be described in Embodiment 2.

Next, based on the relationship between pixel values and the standard deviation value of ISO-induced random noise occurring at each pixel value as illustrated in graphs A to C in FIG. 3, for example, the designated-pixel-value setting unit 103 sets a first designated pixel value and a second designated pixel value respectively corresponding to (i.e., X-axis value where an intersecting point is formed in the graph with) the maximum standard deviation value 300 and the minimum standard deviation value 301. In the following, such a first designated pixel value and a second designated pixel value are respectively referred to as a “same-color-referencing designated pixel value” and a “different-color-referencing designated pixel value”. The designated-pixel-value setting unit 103 according to the present embodiment sets the same-color-referencing designated pixel value and the different-color-referencing designated pixel value for each of the colors R, G, and B. In the example in FIG. 3, a same-color-referencing designated pixel value 302 and a different-color-referencing designated pixel value 303 are set for R, a same-color-referencing designated pixel value 304 and a different-color-referencing designated pixel value 305 are set for G, and a same-color-referencing designated pixel value 306 and a different-color-referencing designated pixel value 307 are set for B.

In step S103, the obtaining unit 101 obtains a RAW image from the image capturing apparatus 1. In step S104, the provisional development unit 102 generates a provisionally developed image by subjecting the RAW image to color interpolation using nearest-neighbor interpolation.

In step S105, based on an interpolation-target pixel value in the provisionally developed image generated by the provisional development unit 102 and the designated pixel values set by the designated-pixel-value setting unit 103, the weight calculation unit 104 calculates a weight to be used in the weighted sum performed by the coefficient calculation unit 105. For example, the weight calculation unit 104 can calculate the weight based on formula (1) shown below.

$${α}_{r} ( x , y ) = \frac{R ( x , y ) - R\_PVs}{R\_PVd - R\_PVs} \qquad Formula ( 1 )$$

Here, (x, y) are the coordinates of the interpolation-target pixel in the RAW image, and R(x, y) is the R pixel value in the provisionally developed image at the coordinates (x, y). Furthermore, R_PVs indicates the same-color-referencing designated pixel value 302 for R, and R_PVd indicates the different-color-referencing designated pixel value 303 for R. αᵣ(x, y) indicates the weight set with respect to the R pixel value at the coordinates (x, y), and the value range thereof here is 0 to 1. Note that steps S105 and S106 are executed for all pixels, with one of the pixels in the image being set as the processing target.

Here, the weight calculation unit 104 calculates αᵣ(x, y) based on formula (1) if R_PVs≤R(x, y)≤R_PVd holds true. Furthermore, the weight calculation unit 104 sets αᵣ(x, y) to 0 if R(x, y)<R_PVs holds true, and to 1 if R_PVd<R(x, y) holds true. In regard to such setting of the weight αᵣ(x, y) in accordance with the value of R(x, y), the three following cases will be described.

The first case is when R(x, y)<R_PVs holds true. This is a case in which the R pixel value R(x, y) falls below the same-color-referencing designated pixel value 302, and it can be expected that noise superimposed on the pixel would be prominent in such a case. Accordingly, in such a case, noise can be reduced by setting the weight (α(x, y)) used in later-described formula (3) to 0 and thereby eliminating the effect of different-color-referencing interpolation from the developed image.

The second case is when R_PVd<R(x, y) holds true. This is a case in which the R pixel value R(x, y) exceeds the different-color-referencing designated pixel value 303, and it can be expected that noise superimposed on the pixel would be hardly noticeable in such a case. Accordingly, in such a case, a high-quality image can be obtained without the occurrence of prominent noise by setting the weight (α(x, y)) used in later-described formula (3) to 1 and thereby generating the pixel after development by different-color-referencing interpolation.

The third case is when R_PVs≤R(x, y)≤R_PVd holds true. This is a case in which the R pixel value R(x, y) is higher than or equal to the same-color-referencing designated pixel value 302 and equal to or lower than the different-color-referencing designated pixel value 303, and it can be expected that, in such a case, noise would be superimposed on the pixel to the extent that the noise would be present but not very prominent. Accordingly, in such a case, the effect of different-color-referencing interpolation and the effect of same-color-referencing interpolation in development can be adjusted in accordance with the likelihood of occurrence of noise by calculating the weight (α(x, y)) used in later-described formula (3) within the range of 0 to 1 based on formula (1).

Here, αᵣ(x, y) is a weight calculated for the color R (red), and each of a weight α_{g}(x, y) for the color G (green) and a weight α_{b}(x, y) for the color B (blue) is also calculated similarly.

Furthermore, here, the weight calculation unit 104 sets the final weight α(x, y) as indicated by formula (2) below using the set weights αᵣ(x, y), α_{g}(x, y), and α_{b}(x, y). Here, the smallest value among αᵣ(x, y), α_{g}(x, y), and α_{b}(x, y) is selected as α(x, y).

$$α ( x , y ) = min ( {α}_{r} ( x , y ) , {α}_{g} ( x , y ) , {α}_{b} ( x , y ) ) \qquad Formula ( 2 )$$

FIGS. 4A to 4D are diagrams for describing development processing performed by the image processing apparatus 100 according to the present embodiment for an image in which a subject is imaged. FIG. 4A shows an imaging-target subject wearing a white dress. FIG. 4B is a RAW image which has been output from a Bayer-pattern image sensor and in which the subject in FIG. 4A is imaged. FIG. 4C is a provisionally developed image obtained by developing the RAW image in FIG. 4B using nearest-neighbor interpolation. FIG. 4D is a diagram in which the weight α(x, y) calculated for individual pixels in the provisionally developed image is visualized such that pixel color is black if the weight is 0, and pixel color becomes whiter with a weight closer to 1. In FIG. 4D, the value for coordinates of a pixel which has a low pixel value and on which ISO-induced random noise is likely to be superimposed becomes closer to 0 as shown by coordinates 401; conversely, the value for coordinates of a pixel which has a high pixel value and on which ISO-induced noise is less likely to be superimposed becomes closer to 1 as shown by coordinates 402.

In step S106, the coefficient calculation unit 105 calculates, for each pixel, a third color interpolation coefficient to be used in final development processing by performing a weighted sum of the first color interpolation coefficient and the second color interpolation coefficient using the weight calculated by the weight calculation unit 104. As described above, the first color interpolation coefficient according to the present embodiment is a coefficient used in same-color-referencing interpolation, and the second color interpolation coefficient according to the present embodiment is a coefficient used in different-color-referencing interpolation. In the following, such color interpolation coefficients will be described with reference to FIGS. 5A and 5B.

FIGS. 5A and 5B each illustrate the arrangement of colors in a Bayer pattern, and five-tap interpolation coefficients corresponding to each color. For example, the Bayer pattern illustrated in FIGS. 5A and 5B has an arrangement pattern in which R and G are repeated in even-numbered lines (lines corresponding to even numbers starting from 0), and G and B are repeated in odd-numbered lines (lines corresponding to odd numbers starting from 1). FIG. 5A illustrates reference pixels and same-color-referencing interpolation coefficients when reconstructing the G pixel value at pixel position 502 using same-color-referencing interpolation. As illustrated by pixel position 501 in FIG. 5A, the reference pixels (pixels for which the interpolation coefficient is not 0) include only pixels of the same color (Gin this example). On the other hand, FIG. 5B illustrates reference pixels and different-color-referencing interpolation coefficients when reconstructing the G pixel value at pixel position 505 using different-color-referencing interpolation. As illustrated by pixel positions 503 and 504 in FIG. 5B, the reference pixels include pixels of a different color (R in this example) in addition to those of the same color (G).

The coefficient calculation unit 105 according to the present embodiment can calculate a final color interpolation coefficient Coef(X, Y) by calculating a weighted sum of the same-color-referencing interpolation coefficient and the different-color-referencing interpolation coefficient as described with reference to FIGS. 5A and 5B by performing alpha blending using formula (3) below, for example.

$$Coef ( X , Y ) = Coef\_d ( X , Y ) \times α ( X , Y ) + Coef\_s ( X , Y ) \times ( 1 - α ( X , Y ) ) \qquad Formula ( 3 )$$

Here, (X, Y) indicates coordinates of a five-tap filter coefficient, Coef_d(X, Y) indicates the different-color-referencing interpolation coefficient, and Coef_s(X, Y) indicates the same-color-referencing interpolation coefficient.

For example, if color interpolation of G were performed using the different-color-referencing interpolation coefficient in a case in which R(x, y)<R_PVs holds true (it can be expected that noise superimposed on the pixel would be prominent), noise may be emphasized due to spike noise occurring at R being propagated to G and the luminance of noise in the developed image considerably increasing or decreasing. However, by calculating Coef(X, Y) in such a manner, a developed image having high color fidelity and sharpness can be generated by, in accordance with the value α(x, y), increasing the effect of same-color-referencing interpolation in development for a pixel in which noise may be prominent when different-color-referencing interpolation is used, and using different-color-referencing interpolation for a pixel in which noise would be hardly noticeable even if different-color-referencing interpolation is used. Furthermore, by using a color interpolation coefficient obtained by performing alpha blending as in formula (3), the unnaturalness felt at the boundary corresponding to a switch between different-color-referencing interpolation and same-color-referencing interpolation can be reduced compared to processing of simply switching between different-color-referencing interpolation and same-color-referencing interpolation.

In step S107, the development unit 106 generates a developed image (RGB image) by subjecting the RAW image to color interpolation using the color interpolation coefficient calculated by the coefficient calculation unit 105.

In step S108, the foreground-background separation unit 107 generates a foreground mask image by separating a background image and a foreground region corresponding to a predetermined subject from the developed image generated by the development unit 106. Here, the two following effects can be obtained by performing development using the color interpolation coefficient calculated based on the color interpolation coefficient used in different-color-referencing interpolation, the color interpolation coefficient used in same-color-referencing interpolation, and the weight. Firstly, because a foreground mask image having higher accuracy can be generated, random noise can be prevented from being erroneously detected as the foreground when a binary image is generated using background subtraction, and, in a case in which the background and the foreground are similar in color, the occurrence of missing portions in the foreground mask image can be prevented by further reducing the detection threshold. Secondly, a high-quality foreground image can be generated by performing development in which noise is suppressed for a region in which random noise is likely to occur, and performing development in which higher color fidelity and sharpness can be obtained for a region in which noise is unlikely to occur.

Here, description has been provided assuming that the same-color-referencing interpolation coefficient and the different-color-referencing interpolation coefficient are used as the first color interpolation coefficient and the second color interpolation coefficient; however, there is no particular limitation to this as long as the final color interpolation coefficient used for development is calculated based on two color interpolation coefficients as described above. For example, a configuration may be adopted such that a color interpolation coefficient used in color interpolation with strong smoothing and a color interpolation coefficient used in color interpolation with strong sharpening are used as the first color interpolation coefficient and the second color interpolation coefficient. Furthermore, color interpolation coefficients are integrated by alpha blending based on formula (3) herein; however, a configuration may be adopted such that RGB pixels obtained by color interpolation using the same-color-referencing interpolation coefficient and RGB pixels obtained by color interpolation using the different-color-referencing interpolation coefficient are separately generated, and the two types of RGB pixels are blended using α(x, y). Such a configuration enables integration to be performed similarly even in a case in which one color interpolation coefficient is for linear interpolation (FIR filter) and the other color interpolation coefficient is for nonlinear interpolation (e.g., bicubic or median filter).

Note that the configuration of the image processing system illustrated in FIG. 1 is one example, and there is no particular limitation to such a configuration as long as a RAW image can be similarly developed. For example, the image processing apparatus 100 need not be capable of executing processing that has been described as being executed by the foreground-background separation unit 107, and may be configured to execute types of image processing different therefrom on a developed image.

According to such a configuration, a weight used to perform a weighted sum of the same-color-referencing interpolation coefficient and the different-color-referencing interpolation coefficient can be calculated, and a RAW image can be developed using a color interpolation coefficient calculated using the weight. Accordingly, by appropriately using color interpolation schemes having different characteristics depending on pixel value, degradation in texture and three-dimensional shape can be suppressed in the generation of a virtual viewpoint image.

Here, description has been provided that the weight is set within the range of 0 to 1, inclusive, if R_PVs≤R(x, y)≤R_PVd holds true; however, a configuration may be adopted such that the weight is switched between the two possible values of 0 and 1 based on a predetermined condition. For example, a configuration may be adopted such that: a threshold is set based on the same-color-referencing designated pixel value and the different-color-referencing designated pixel value; 0 and 1 are respectively assigned as weights to the different-color-referencing interpolation coefficient and the same-color-referencing interpolation coefficient if R(x, y) is lower than the threshold; and 1 and 0 are respectively assigned as weights to the different-color-referencing interpolation coefficient and the same-color-referencing interpolation coefficient if R(x, y) is higher than or equal to the threshold.

### Embodiment 2

In Embodiment 1, description has been provided assuming that the maximum standard deviation value 300 and the minimum standard deviation value 301 are values set in advance (hereinafter, such designated pixel values set in advance are referred to as initially set values). However, in a case in which the initially set values are determined in advance by the user visually checking a developed image, the values are not necessarily appropriate for image processing in subsequent processes, and may need to be finely adjusted in accordance with image processing conditions. In view of this, the image processing apparatus 100 according to Embodiment 2 adjusts the designated pixel values based on pixel values in the foreground mask image. In particular, the image processing apparatus 100 can evaluate the noise amount based on rectangular regions detected in a background region of the foreground mask image, and adjust the designated pixel values based on the evaluation of the noise amount.

### <Description of Configuration of Image Processing Apparatus>

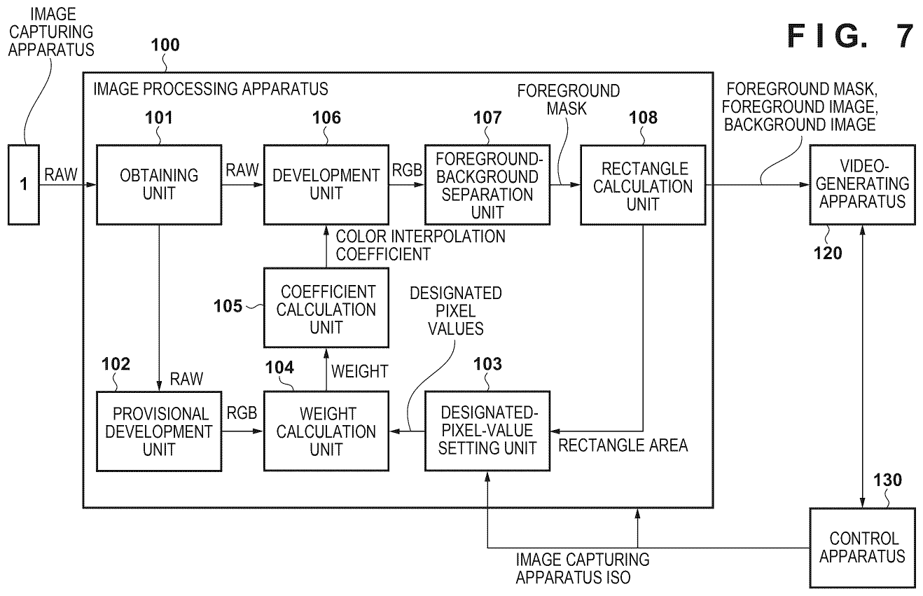

FIG. 7 is a block diagram illustrating an example of an image processing system in the present embodiment; the image processing system generates a virtual viewpoint image and includes the image processing apparatus 100. As does the image processing system illustrated in FIG. 1, the image processing system illustrated in FIG. 7 includes the image capturing apparatus 1, the image processing apparatus 100, the video-generating apparatus 120, and the control apparatus 130. Furthermore, the image processing apparatus 100 according to the present embodiment has the same configuration as and is capable of executing the same processing as those of the image processing apparatus 100 according to Embodiment 1 other than that the image processing apparatus 100 according to the present embodiment includes a rectangle calculation unit 108; thus, redundant description is omitted herein.

The rectangle calculation unit 108 calculates coordinates (circumscribed-rectangle coordinates) of a rectangle circumscribing the foreground region in the foreground mask image generated by the foreground-background separation unit 107. The circumscribed-rectangle coordinates are coordinates of predetermined positions (the four corners herein) of the rectangle circumscribing the foreground region. Such coordinates of the rectangle may be indicated, for example, by information indicating one point (e.g., the upper left corner or the center) of the rectangle, and the shape and size of the rectangle; however, as long as information capable of similarly representing the rectangle is used, the form of the information is not particularly limited. Besides being used for the processing for (automatically) adjusting standard deviation values described in the following, the circumscribed-rectangle coordinates according to the present embodiment can be used to reduce the transmission bandwidth by limiting the foreground image (foreground mask image and foreground image) transmitted to the video-generating apparatus 120 to the region within the circumscribed rectangle.

### <Description of Method for Automatically Adjusting Standard Deviation Values>

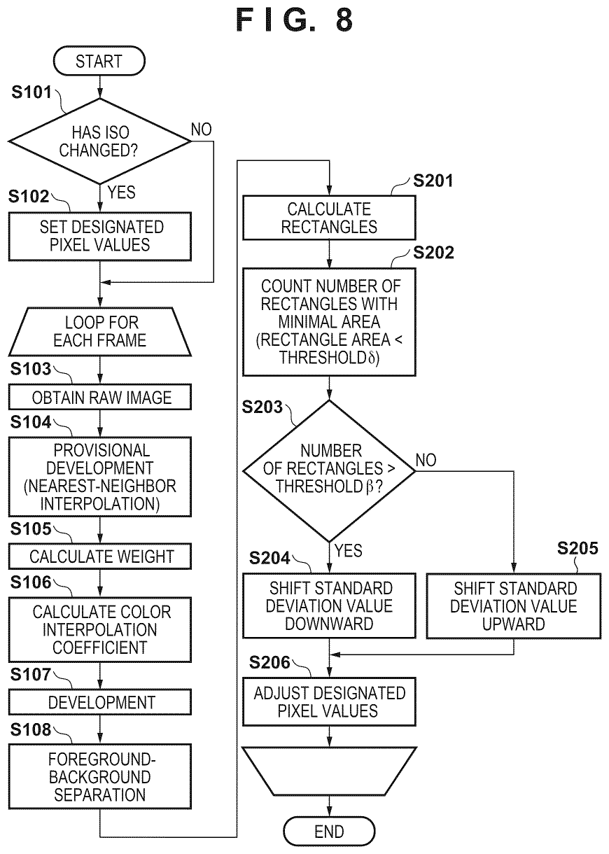

In the following, processing executed by the image processing apparatus 100 according to the present embodiment will be described with reference to the flowchart in FIG. 8. In the processing illustrated in FIG. 8, subsequent steps S201 to S206 are added to steps S101 to S108 described with reference to FIG. 1; thus, redundant description is omitted herein.

In step S201 subsequent to step S108, the rectangle calculation unit 108 calculates the circumscribed-rectangle coordinates of the foreground region within the foreground mask image generated in step S108.

In step S202, the designated-pixel-value setting unit 103 counts, within a single frame, the number of rectangles having an area no larger than a predetermined area. Here, first, the designated-pixel-value setting unit 103 uses the foreground mask image corresponding to a single frame as the processing target, and detects rectangular regions that are present (with only pixel values of 1 or only pixel values of 0) within the processing-target image. Subsequently, for each of the detected rectangular regions, the designated-pixel-value setting unit 103 can compare the area of the rectangle (the number of pixels in the rectangle) and a preset threshold δ, and the designated-pixel-value setting unit 103 can count the number of rectangles having an area smaller than the threshold as the number of rectangles having an area no larger than the predetermined area. Here, the threshold δ can be set as a value that is sufficiently smaller than the area of the rectangle circumscribing the subject detected as the foreground. Such processing enables differences other than the subject detected by background subtraction, i.e., the quantity of random noise that was not successfully separated using the binarization threshold, to be measured.

In step S203, the designated-pixel-value setting unit 103 determines which of the number of rectangles counted in step S202 and a threshold β is greater. The degree of the amount of random noise in the processing-target frame is evaluated by this comparison between the number of rectangles and the threshold β. Here, as a threshold for determining the magnitude of the amount of random noise present in a single frame, the threshold β can be set, as appropriate, as a value more than or equal to 0 in accordance with the imaging conditions. Processing advances to step S204 if the number of rectangles is more than the threshold β, and processing advances to step S205 if the number of rectangles is equal to or less than the threshold β.

In step S204, the designated-pixel-value setting unit 103 shifts downward (reduces by a predetermined amount) the maximum standard deviation value 300 and the minimum standard deviation value 301 illustrated in graph A in FIG. 3. Here, the designated-pixel-value setting unit 103 reduces the maximum standard deviation value 300 and the minimum standard deviation value 301 each by a predetermined value. The reduction value applied to the maximum standard deviation value 300 and the minimum standard deviation value 301 in step S204 is not particularly limited, and different values may be applied to the maximum standard deviation value 300 and the minimum standard deviation value 301; however, it is assumed here that a shift by a value 0.01 in the reducing direction is uniformly performed.

In step S205, the designated-pixel-value setting unit 103 shifts upward (increases by a predetermined amount) the maximum standard deviation value 300 and the minimum standard deviation value 301. The processing executed in step S205 is executed similarly to that in step S204 other than that the values are increased instead of being reduced.

In step S206, the designated-pixel-value setting unit 103 adjusts the designated pixel values in accordance with the shift direction and shift amount determined in step S204 or S205. If the maximum standard deviation value and the minimum standard deviation value are shifted downward, the same-color-referencing designated pixel value 302 and the different-color-referencing designated pixel value 303 illustrated in graph A in FIG. 3 shift toward the right on the X axis in FIG. 3. Thus, the range of pixel values to which the same-color-referencing interpolation coefficient is applied expands, and noise is suppressed to a further extent. Furthermore, if the maximum standard deviation value and the minimum standard deviation value are shifted upward, the same-color-referencing designated pixel value 302 and the different-color-referencing designated pixel value 303 shift toward the left on the X axis. Thus, the range of pixel values to which the different-color-referencing interpolation coefficient is applied expands, and edge/color representation performance is enhanced.

Here, the designated pixel values are adjusted in accordance with the number of rectangles detected in the foreground mask image; however, the designated pixel values may be adjusted based on a different value. According to such processing, the noise amount can be evaluated based on rectangular regions detected in the background region of the foreground mask image, and the designated pixel values can be adjusted based on the evaluation of the noise amount.

### Embodiment 3

Description has been provided in which the image processing apparatus 100 according to Embodiment 2 adjusts the designated pixel values by measuring noise amount based on rectangular regions detected in the foreground mask image. On the other hand, the image processing apparatus 100 according to Embodiment 3 adjusts the designated pixel values by performing frequency analysis on the region within the rectangle circumscribing the foreground region in the developed image and thereby measuring noise amount. Here, the foreground region is set using the foreground mask image as mentioned earlier; however, the foreground region may be set directly from the developed image.

### <Description of Configuration of Image Processing Apparatus>

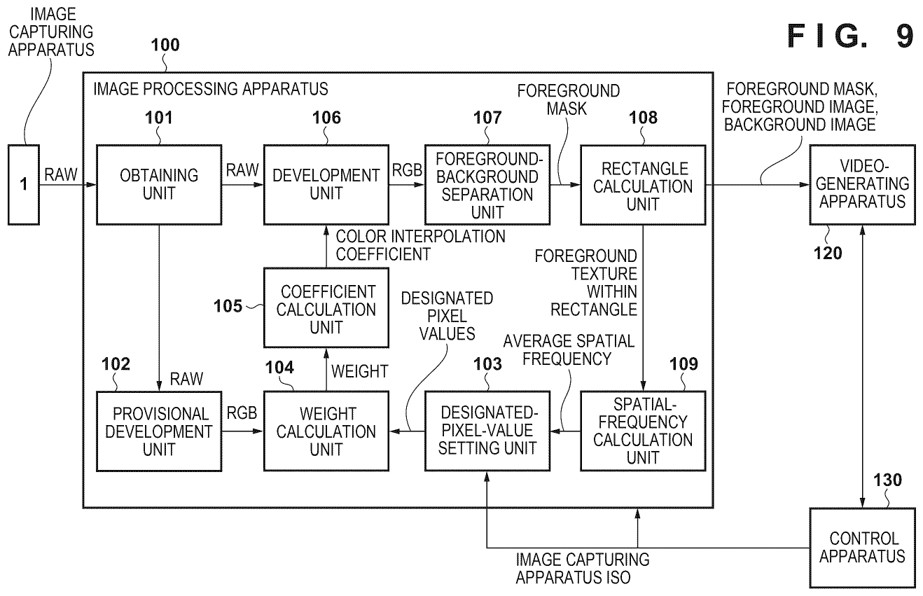

FIG. 9 is a block diagram illustrating an example of an image processing system in the present embodiment; the image processing system generates a virtual viewpoint image and includes the image processing apparatus 100. As does the image processing system illustrated in FIG. 1, the image processing system illustrated in FIG. 9 includes the image capturing apparatus 1, the image processing apparatus 100, the video-generating apparatus 120, and the control apparatus 130. Furthermore, the image processing apparatus 100 according to the present embodiment has the same configuration as and is capable of executing the same processing as those of the image processing apparatus 100 according to Embodiment 2 other than that the image processing apparatus 100 according to the present embodiment includes a spatial-frequency calculation unit 109; thus, redundant description is omitted herein.

The spatial-frequency calculation unit 109 calculates the average spatial frequency by performing frequency analysis on the region within the rectangle circumscribing the foreground region in the developed image. The processing by the spatial-frequency calculation unit 109 will be described later.

### <Description of Method for Automatically Adjusting Standard Deviation Values>

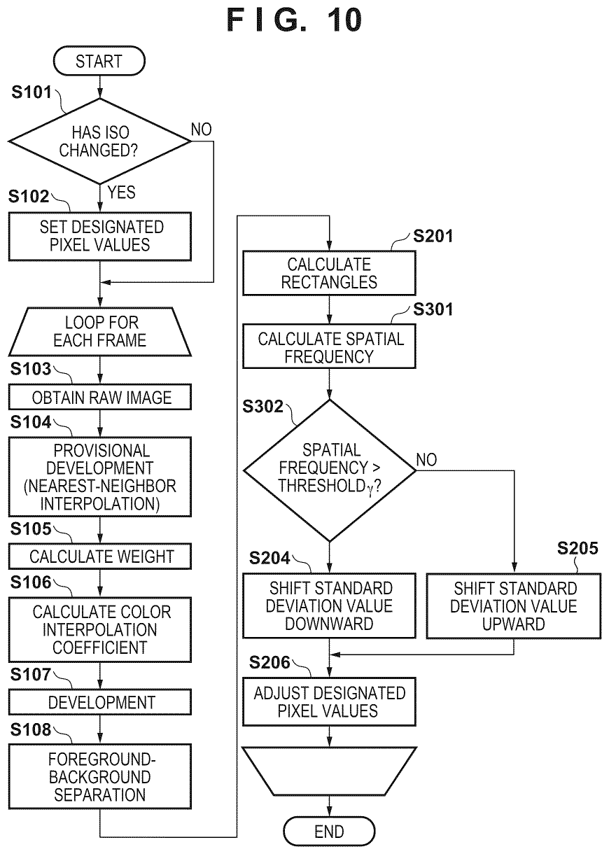

In the following, processing executed by the image processing apparatus 100 according to the present embodiment will be described with reference to the flowchart in FIG. 10. The processing illustrated in FIG. 10 is executed similarly to the processing illustrated in FIG. 8 other than that steps S301 and S302 are executed in place of steps S202 and S203; thus, redundant description is omitted herein.

In step S301, the spatial-frequency calculation unit 109 calculates the average spatial frequency of the region within the rectangle circumscribing the foreground region in the developed image. For example, the spatial-frequency calculation unit 109 can calculate the average spatial frequency as follows. First, the spatial-frequency calculation unit 109 applies two-dimensional FFT to the developed image within the circumscribed rectangle as described above (rectangular image including the subject) for conversion into frequency-axis amplitude information. Next, the spatial-frequency calculation unit 109 calculates a weighted average over all frequencies using the amplitude value at each frequency as the weight. This calculation of weighted average is performed for all rectangular images within a single frame. Next, the spatial-frequency calculation unit 109 calculates, as the average spatial frequency, the average (weighted average per rectangular image) of the weighted averages of all rectangular images. It is known through experimentation that this average spatial frequency increases in accordance with the amount of ISO-induced random noise; thus, by adjusting the designated pixel values based on such an average spatial frequency, color interpolation schemes having different characteristics can be appropriately used in accordance with the amount of random noise.

In step S302, the designated-pixel-value setting unit 103 determines which of the average spatial frequency calculated in step S301 and a threshold γ is greater. The degree of the amount of random noise in the processing-target developed image is evaluated by this comparison between the average spatial frequency and the threshold γ. Here, the threshold γ can be set, as appropriate, as a threshold for determining the magnitude of the amount of random noise present within a developed image. For example, as the threshold γ, an average spatial frequency that can be used to determine that there is not much noise in a developed image (e.g., an average spatial frequency measured at ISO 400, which does not introduce much ISO-induced noise, or the like) can be set. Processing advances to step S204 if the average spatial frequency is higher than the threshold γ, and processing advances to step S205 if the average spatial frequency is equal to or lower than the threshold γ.

According to such processing, the average spatial frequency of the region within the rectangle circumscribing the foreground region in the developed image can be calculated, and the designated pixel values can be adjusted based on the average spatial frequency. Accordingly, color interpolation schemes having different characteristics can be appropriately used in accordance with the amount of random noise.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-010641, filed Jan. 24, 2025, which is hereby incorporated by reference herein in its entirety.

What is claimed is:

1. An image processing apparatus comprising:
one or more memories storing instructions; and
one or more processors executing the instructions to:
obtain a RAW image output from a Bayer-pattern image sensor;
set a first pixel value and a second pixel value that is higher than the first pixel value;
calculate a first weight to be used in a weighted sum based on the first pixel value, the second pixel value, and a third pixel value that is a pixel value of an interpolation-target pixel in an image to be subjected to color interpolation;
calculate a third color interpolation coefficient by performing a weighted sum of a first color interpolation coefficient and a second color interpolation coefficient using the first weight; and
develop the RAW image using the third color interpolation coefficient.

2. The image processing apparatus according to claim 1, the one or more processors further executing the instructions to
develop the RAW image using a second color interpolation method that is different from a first color interpolation method used in the development using the third color interpolation coefficient,
wherein the image subjected to color interpolation is the developed RAW image using the second color interpolation method.

3. The image processing apparatus according to claim 2,
wherein the one or more processors develop the RAW image by nearest-neighbor interpolation as the second color interpolation method.

4. The image processing apparatus according to claim 1,
wherein the one or more processors set, as the first pixel value and the second pixel value, a third pixel value and a fourth pixel value corresponding to an R pixel value, a fifth pixel value and a sixth pixel value corresponding to a G pixel value, and a seventh pixel value and an eighth pixel value corresponding to a B pixel value, and
the one or more processors
calculate a second weight based on the third pixel value, the fourth pixel value, and a ninth pixel value that is an R pixel value of the interpolation-target pixel,
calculate a third weight based on the fifth pixel value, the sixth pixel value, and a tenth pixel value that is a G pixel value of the interpolation-target pixel,
calculate a fourth weight based on the seventh pixel value, the eighth pixel value, and an eleventh pixel value that is a B pixel value of the interpolation-target pixel, and
adopt a smallest value among the second weight, the third weight, and the fourth weight as the first weight.

5. The image processing apparatus according to claim 4,
wherein the one or more processors set the third pixel value, the fourth pixel value, the fifth pixel value, the sixth pixel value, the seventh pixel value, and the eighth pixel value based on a relationship between a pixel value and a standard deviation value of random noise, the relationship being based on an ISO value of an image capturing apparatus.

6. The image processing apparatus according to claim 1,
wherein the one or more processors calculate a weight to be applied to the first color interpolation coefficient in the weighted sum such that
the weight is 0 if the third pixel value is lower than the first pixel value,
the weight is 1 if the third pixel value is higher than the second pixel value, and
the weight is a value determined to be 0 or more and 1 or less based on values of the first pixel value and the second pixel value if the third pixel value is higher than or equal to the first pixel value and lower than or equal to the second pixel value.

7. The image processing apparatus according to claim 1,
wherein the first color interpolation coefficient is a color interpolation coefficient used in different-color-referencing interpolation, and the second color interpolation coefficient is a color interpolation coefficient used in same-color-referencing interpolation.

8. The image processing apparatus according to claim 1, the one or more processors further executing the instructions to
adjust the first pixel value and the second pixel value.

9. The image processing apparatus according to claim 8, the one or more processors further executing the instructions to
generate a foreground mask image obtained by separating a subject from the developed RAW image using the first color interpolation method,
wherein the one or more processors adjust the first pixel value and the second pixel value based on a pixel value in the foreground mask image.

10. The image processing apparatus according to claim 9,
wherein the one or more processors adjust the first pixel value and the second pixel value based on a total number of rectangular regions detected in a background region of the foreground mask image.

11. The image processing apparatus according to claim 10,
wherein the one or more processors increase the first pixel value and the second pixel value if the total number of rectangular regions detected in the background region of the foreground mask image exceeds a first threshold, and reduces the first pixel value and the second pixel value if the total number of rectangular regions detected in the background region of the foreground mask image is lower than or equal to the first threshold.

12. The image processing apparatus according to claim 8, the one or more processors further executing the instructions to analyze a spatial frequency of an image within a foreground region corresponding to a subject in the developed RAW image using the first color interpolation method,
wherein the one or more processors adjust the first pixel value and the second pixel value based on the spatial frequency of the image within the foreground region.

13. The image processing apparatus according to claim 12,
wherein the one or more processors increase the first pixel value and the second pixel value if the spatial frequency exceeds a second threshold, and reduces the first pixel value and the second pixel value if the spatial frequency is lower than or equal to the second threshold.

14. An image processing method comprising:
obtaining a RAW image output from a Bayer-pattern image sensor;
setting a first pixel value and a second pixel value that is higher than the first pixel value;
calculating, based on the first pixel value, the second pixel value, and a third pixel value that is a pixel value of an interpolation-target pixel in an image to be subjected to color interpolation, a first weight to be used in a weighted sum;
calculating a third color interpolation coefficient by performing a weighted sum of a first color interpolation coefficient and a second color interpolation coefficient using the first weight; and
developing the RAW image using the third color interpolation coefficient.

15. A non-transitory computer-readable storage medium configured to store program that, when executed by a computer, causes the computer to perform an information processing method, the information processing method comprising:
obtaining a RAW image output from a Bayer-pattern image sensor;
setting a first pixel value and a second pixel value that is higher than the first pixel value;
calculating, based on the first pixel value, the second pixel value, and a third pixel value that is a pixel value of an interpolation-target pixel in an image to be subjected to color interpolation, a first weight to be used in a weighted sum;
calculating a third color interpolation coefficient by performing a weighted sum of a first color interpolation coefficient and a second color interpolation coefficient using the first weight; and
developing the RAW image using the third color interpolation coefficient.
